(19) United States
(12) Patent Application Publication
(10) Pub. No.: US 2003/0149627 A1
(43) Pub. Date: Aug. 7, 2003

(54) Method and apparatus for interaffiliate marketing

(75) Inventors: James T. Brady, San Jose, CA (US); Scott W. Slinker, San Jose, CA (US)

Correspondence Address: PAUL D. GREELEY, ESQ., OHLANDT, GREELEY, RUGGIERO & PERLE, L.L.P., 10th FLOOR, ONE LANDMARK SQUARE, STAMFORD, CT, 06901-2682, US

(73) Assignee: Paul D. Greeley

(21) Appl. No.: 10/390,474

(22) Filed: Mar. 17, 2003

Related U.S. Application Data
(63) Continuation of application No. 09/497,744, filed on Feb. 4, 2000, now abandoned.

(51) Int. Cl. G06F 17/60

(52) U.S. Cl. 705/14; 705/10

(57) ABSTRACT

Apparatus, and a corresponding method, for arranging presentation of advertising, sales, promotional, and educational campaigns to selected user of computer interfaces in one or more locations, that meet demographic requirements of campaign. Apparatus collects Information about campaign, capacity of various locations, characteristics of locations, and characteristics of users of those locations. Apparatus uses information to negotiate cost of campaign; to conclude a contract for campaign; to schedule, distribute, present, and measure campaign; and to report result of campaign to involved parties.

### FIELD OF INVENTION

This invention relates to a method of matching requirements for various marketing activities from a number of businesses or organizations, with capabilities of other businesses or organizations to perform these activities. These marketing activities include: advertising a product, service, or idea; offering discounts on a product or service in form of an advertisement or coupon; and offering product or service for sale. These are collectively called “offers”.

### BACKGROUND OF INVENTION

This invention relates generally to brokerage of sales opportunities on point-of-sale computer systems of type used in retail locations, gas stations and banks. Specifically, the invention relates to a system that allows potential advertisers to prepare sales or publicity campaigns that are delivered by point-of-sale systems, kiosks, ATMs and similar systems, that can handle presentation of visual and/or audio information to customer and optionally allow that customer to respond to that information. These campaigns make one or more offers to customers of these locations. An offer is made in form of graphical images, text, video clips, sound clips and other means, with objective of: presenting a brand name and/or logo, advertising (an indirect offer to sell product), offering a discount on product, issuing a coupon for a fixed amount, offering an opportunity to complete a sale or to receive more information, etc.

Today one of key problems of a sales or publicity campaign is non-specificity of presentation to individuals that represent market for campaign. Ads in newspapers reach a far larger population than campaign is targeting. For instance, a campaign that wants to reach new parents could place an ad with a coupon in Sunday newspaper. The price for this ad is based on readership of the paper, not the number of new parents. As new-parents are a small portion of the subscribers of a paper, most sales campaigns spend a great deal of money on a statistical attempt to reach market. In the ‘new parent’ case, advertisers have a much more efficient way to target their customers, as new births are in the public record. This gives a direct lead to potential customer and opportunity to increase visibility of the ad through direct mail or phone contact.

In the general case these direct leads are not available to the marketer, and billions of coupons, ads, phone call . . . are produced with limited effect. About 0.7% of coupons delivered by newspaper are redeemed. Thus the strategy for making an offer is key to the effectiveness of the offer.

If a Company A, a fast food company, wants to promote their new Super—Fries product introduction in Sacramento Calif., they would be ill advised to make an offer in a competing Sacramento fast food chain, or in a gas station in Great Falls Mont. However, presenting an offer at all gas stations, grocery stores, and variety stores within 10 blocks of all participating Company A's locations in Sacramento, after 3:30 PM and before 9:00 PM, may be an excellent promotion strategy.

Another problem is the lead-time to deliver a campaign into the market. A month or more is needed to put a conventional advertising campaign into place. Once in place, the measurements needed to determine its effectiveness take one to two months to get back to the advertiser, and an additional few weeks is required to plan and make adjustments to the campaign. These delays limit the effectiveness of campaigns and make it difficult to direct campaigns based on current information.

### SUMMARY OF INVENTION

This invention relates to a system that addresses the above-noted problems by allowing presentation of offers to customers in an environment where they have little reason to not pay attention, where information exists that allows more precisely targeting of the offering; and where the advertiser has a short lead time to activating the campaign, receiving measurements, and making adjustments to the campaign.

The method of the invention involves: collection of information about campaigns advertisers wishes to conduct, collection of information about locations with User Interface units, collection of information about customers in these locations, determination of the capacity of the system to present the campaign, matching of the campaign to locations and customers of those locations, arrangement of contracts between the advertisers and the various location owners, and the delivery and presentation of campaigns in the form of offers, to customers at various locations. All of these activities are conducted in a manner that minimizes the delay between the availability of information and its use, thereby providing a responsive and adaptive system for conducting advertising campaigns.

### BRIEF DESCRIPTION OF THE DRAWINGS

FIG. 1. Is a block diagram depicting an overview of the present invention;

FIG. 2. Is a block diagram of an Advertiser's Workstation;

FIG. 3. Is a block diagram of a Central Server;

FIG. 4. Is a block diagram of a Location Server;

FIG. 5. Graphically depicts a User Interface according to the present invention;

FIG. 6. Is a block diagram of a Presenter's Workstation;

FIG. 7. Is a Campaign Table;

FIG. 8. Is a Location Table;

FIG. 9. Is an Advertisers Table;

FIG. 10. Is a Presenters Table;

FIG. 11. Is an Instrumentation Table;

FIG. 12. Is a Location Profile Table;

FIG. 13. Is a Customer/Location Profile Table;

FIG. 14. Is a Location Demographics Table;

FIG. 15. Is a Location Campaign Rules Table;

FIG. 16. Is an Activity Dialog Table;

FIG. 17. Is a Location Activity List;

FIG. 18. Is an Advertisers' Offers Table;

FIGS. 19a-19-d. Is a flow diagram of an Activity Manager according to the present invention;

FIGS. 20a-20d. Is a flow diagram of a Campaign Manger according to the present invention;

FIG. 21. Is a Point of Sale Terminal Table;

FIG. 22. Is a Presenter's Offers Table; and

FIG. 23. Is a Joint Campaign Table.

### DETAILED DESCRIPTION OF INVENTION

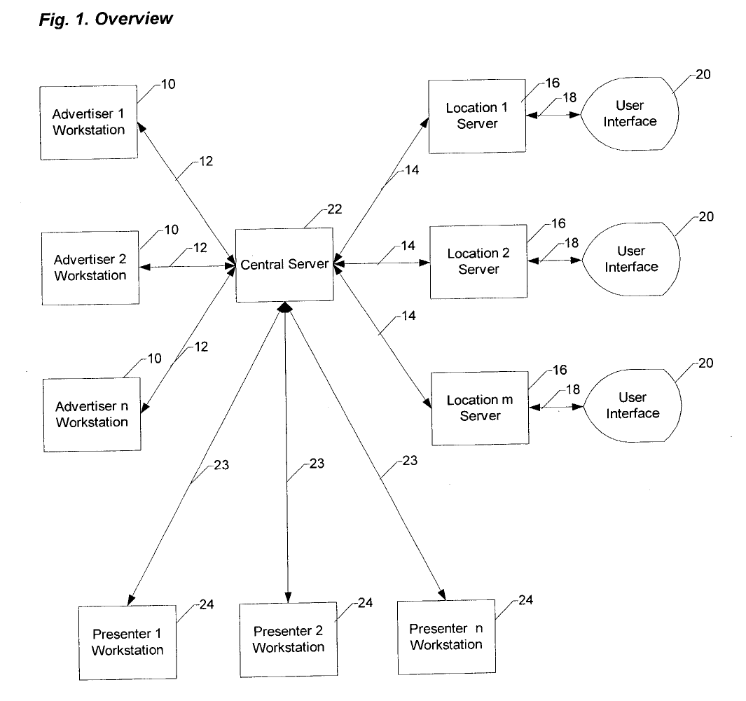

FIG. 1. describes a system that enables businesses with advertising needs and businesses having User Interfaces 20 that are capable of presenting offers to customers to match their requirements and capabilities, based on the demographics of both locations and customers of those locations, in a manner that minimizes the delay between the availability of information and its use. In FIG. 1, a number of advertisers use Advertiser Workstations 10 to prepare descriptions of advertising campaigns they wish to conduct. In some cases campaigns are built by collaboration between advertisers. Advertiser Workstations 10 contain tools for creating offers and defining how those offers are delivered to the marketplace. Those tools include various media editors including graphics, text, sound, and video editors, for producing assets required for offers, (Assets include screens, video clips, sound clips, or printed material descriptions needed for the campaign.) and the demographic and geographic requirements of the campaign. They also include tools to find presenting locations at which to make offers, such locations having one or more User Interfaces 20 as described below, for presenting the offers. Additionally, these tools have access to the geographic and demographic information about potential presenting locations, which are represented by Location Servers 16.

Campaigns are built by interacting with other tools and databases on Central Server 22, which also coordinates information when a collaborative campaign is being developed. This interaction is conducted via a Local Area Network (LAN) or Wide Area Network (WAN) represented by 12.

Presenter Workstations 24 are used by representatives of presenting merchants to build entries in Central Server 22 databases describing each location's geographic and demographic information, and defining rules concerning types of campaigns they are willing to present at each location (represented by Location Servers 16). Presenter Workstations 24 also present to these representatives potential campaigns as proposed by advertisers via Advertiser Workstation 10. Representatives will examine the campaign materials and proposed compensation, making a decision to accept, counteroffer, or reject the campaign. This communication between Presenter Workstations 24 and Central Server 22 is conducted via a Wide Area Network (WAN) represented by 23.

Central Server 22 acts as a central repository for data received from Advertiser Workstations 10 and Presenter Workstations 24, and acts as a broker between advertisers and presenters. This brokerage is done at two levels. First is an automatic brokerage, and occurs when advertiser's Campaign Rules and Presenters Rules are compatible. The second level is done via Central Server 22 managed dialog between advertiser and presenter. Central Server 22 also manages distribution, measurement, reporting, and accounting for campaigns.

Campaigns are distributed by Central Server 22 to Location Servers 16 via Wide Area Network (WAN) 14, according to a campaign plan built by the advertiser and accepted by various presenters. A Location Server 16 merges campaign information into its database with other campaigns. Then as customers use User Interface 20 and identify or not identify themselves, information is transmitted by LAN 18 to a Location Server 16, which selects offers to present to each customer and sends them via LAN 18 to User Interface 20 for presentation.

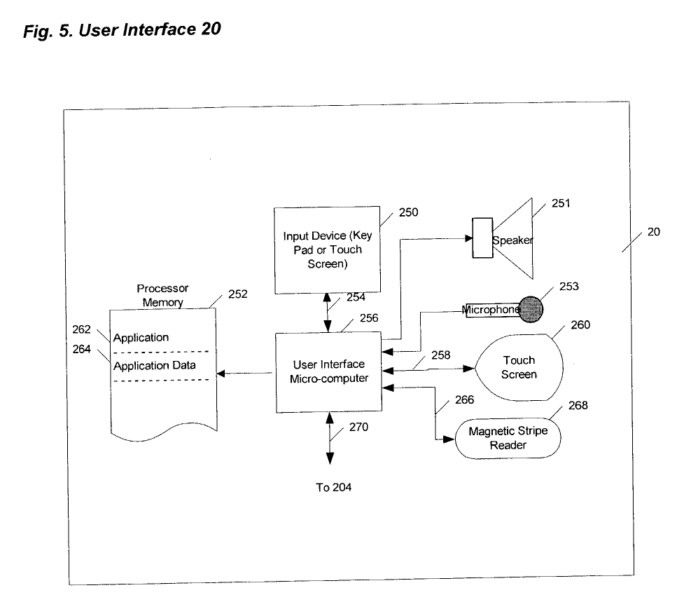

User Interface 20 is a computer system as described in FIG. 5. It has an application that can receive assets and a description of how to use assets from a Location Server 16, and then to present them to the customer, and to capture a response from the customer. User Interface 20 uses the response to determine the next asset to be presented and forwards the response to Location Server 16.

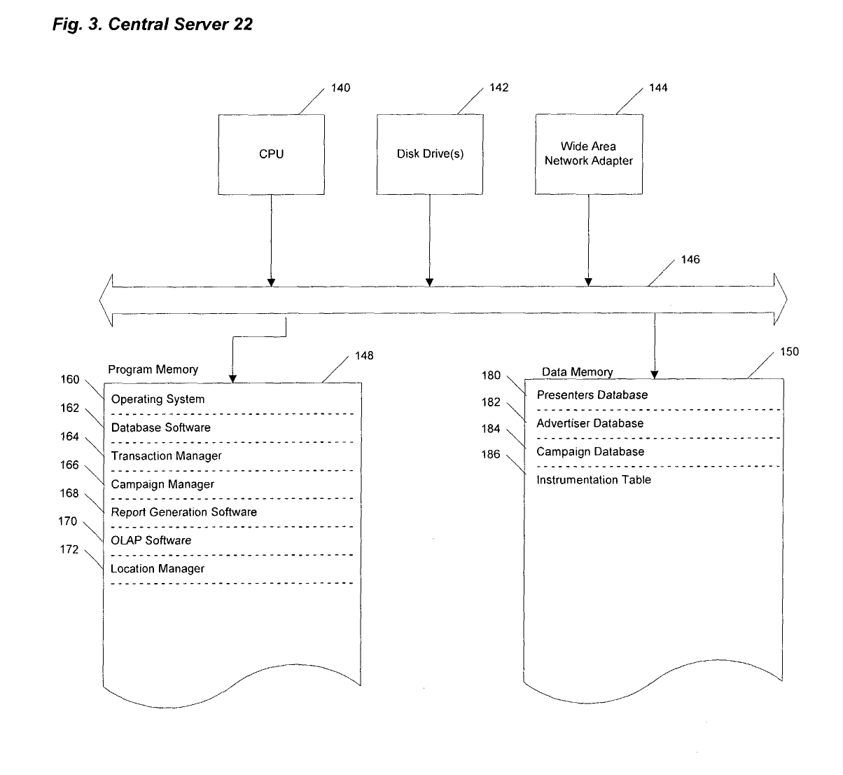

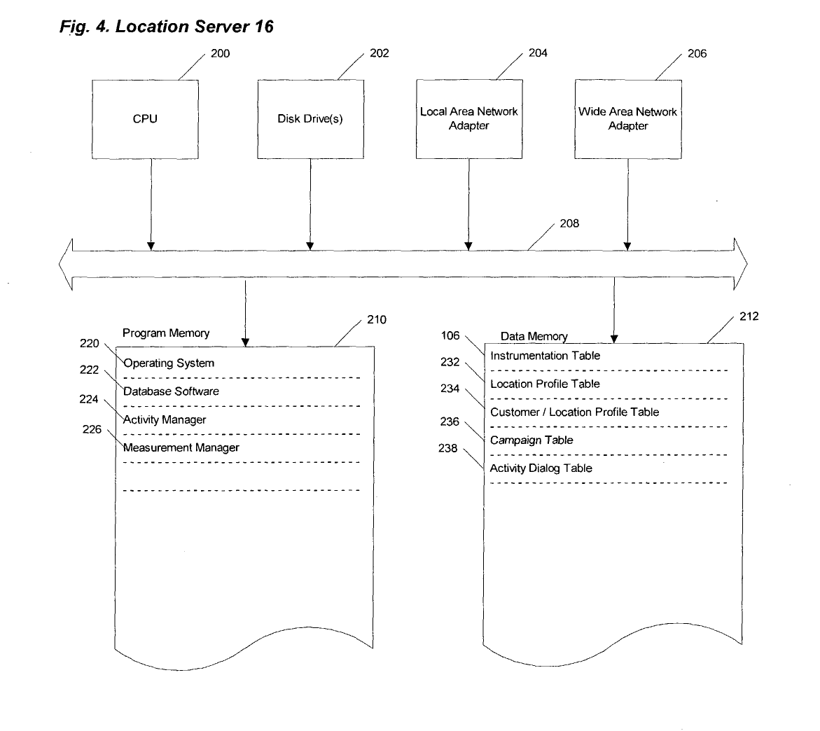

Location Server 16 is a computer system as described in FIG. 4. It stores campaign information and tells User Interface 20 what campaigns to present and how to present them. Location Server 16 also records the responses from User Interface 20 and builds an Instrumentation Table 560 that is sent to Central Server 22 via WAN 16 14. Central Server 22 is a computer system as described in FIG. 3, it uses information from Advertiser Workstation 10 and Presenter Workstation 24 to build campaigns, delivers those campaigns to Location Server 16, and uses information reported back from Location Server 16 to report on various campaigns, bills advertisers for work done, receives payments, and distributes payments according to terms agreed to for the various campaigns. Reports are made available via Advertiser Workstations 10 and Presenter Workstations 24.

The system described here, allows advertiser to rapidly prepare, run, and receive feedback on sales campaigns. Based on feedback, an advertiser can make modifications to the campaign strategy and activate a new strategy on a timely basis. Similarly, presenting merchants can adjust their rules and pricing, based on the demand for User Interface 20 time, and their presentation rules in order to maximize the profitability extracted from their User Interfaces 20.

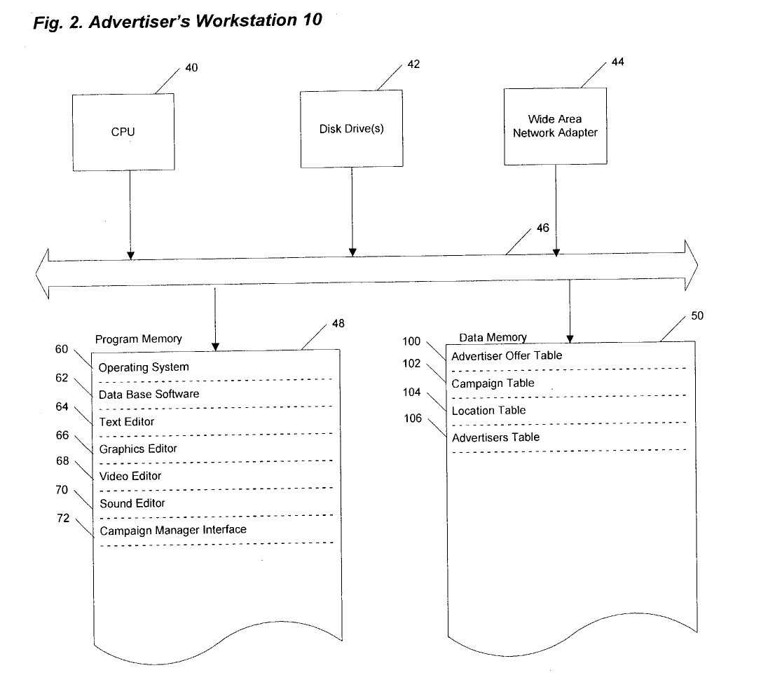

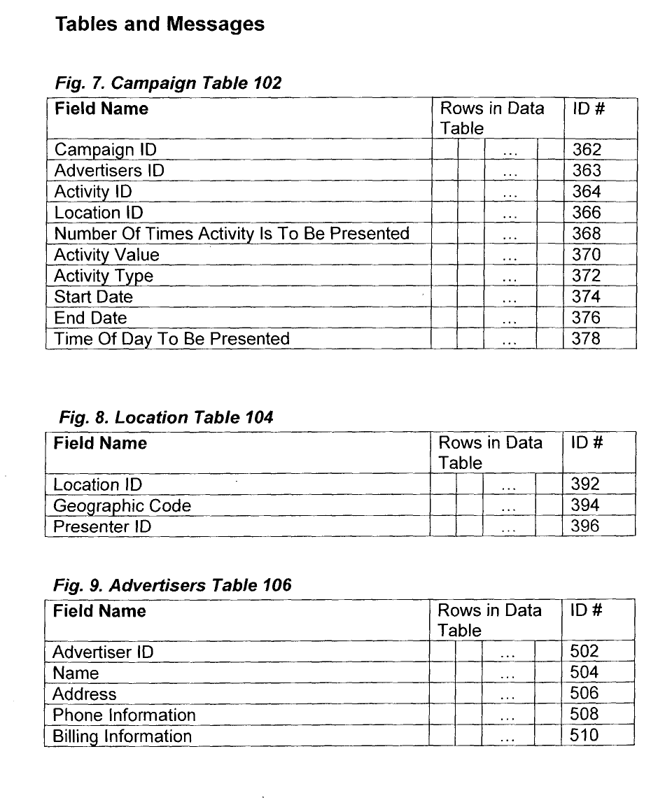

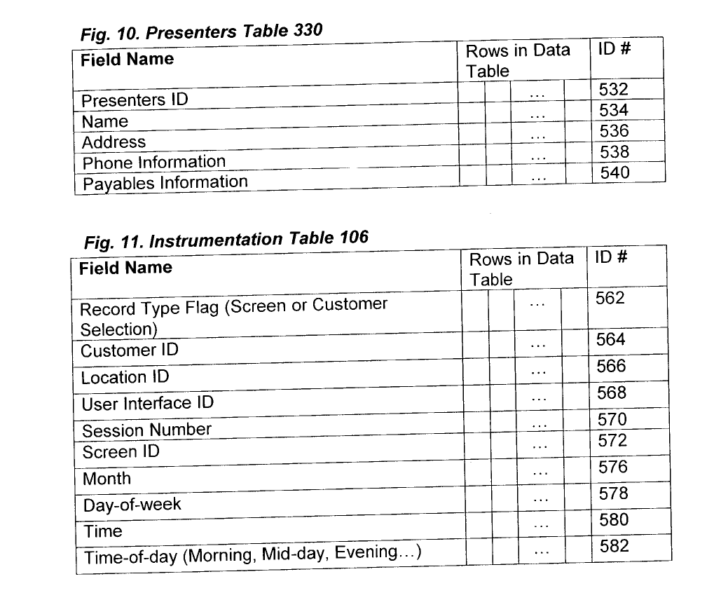

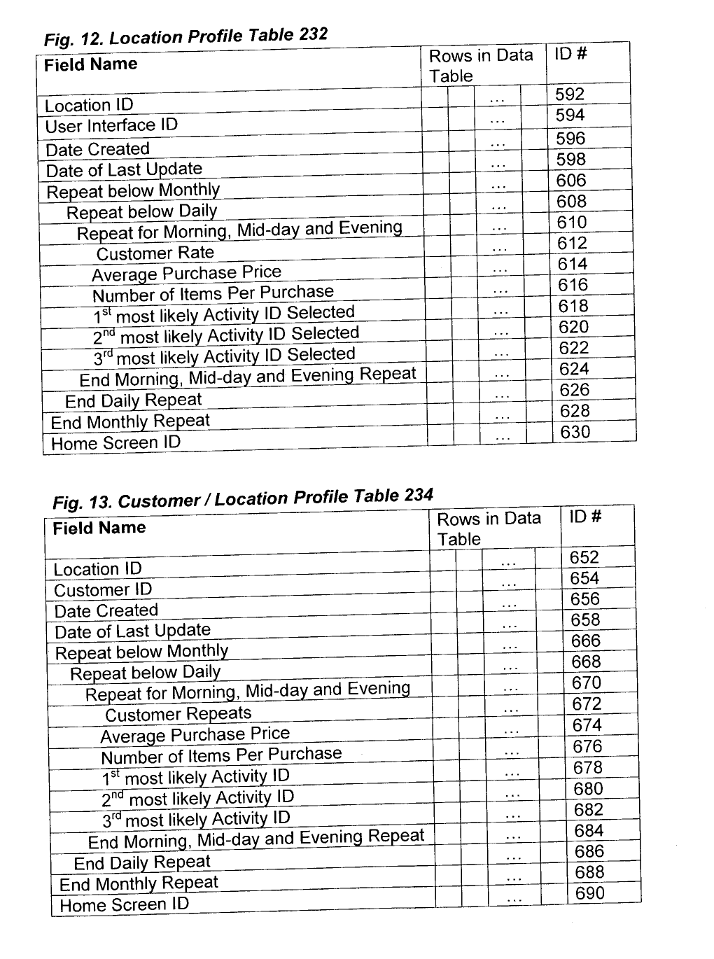

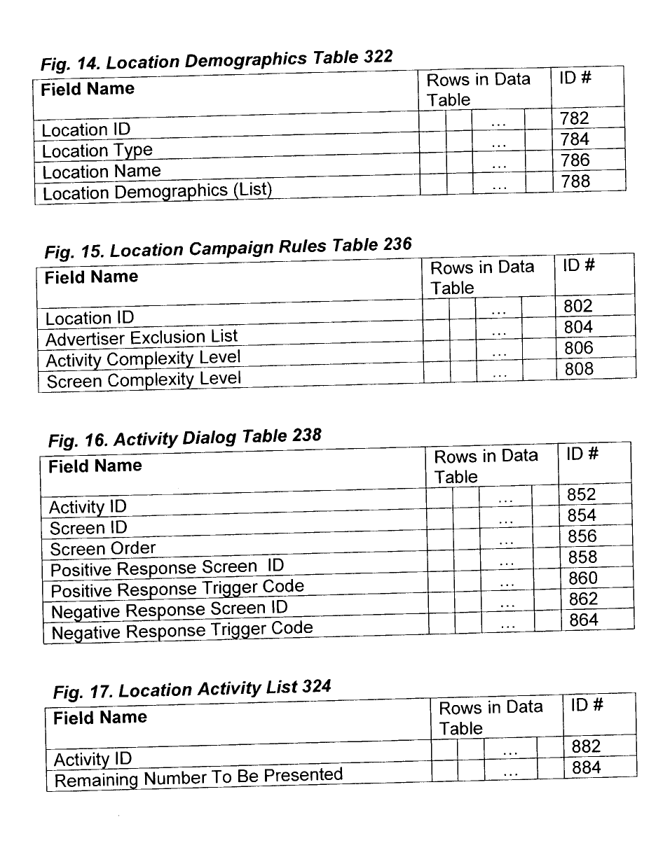

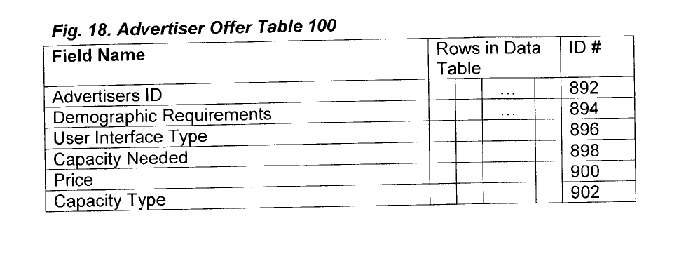

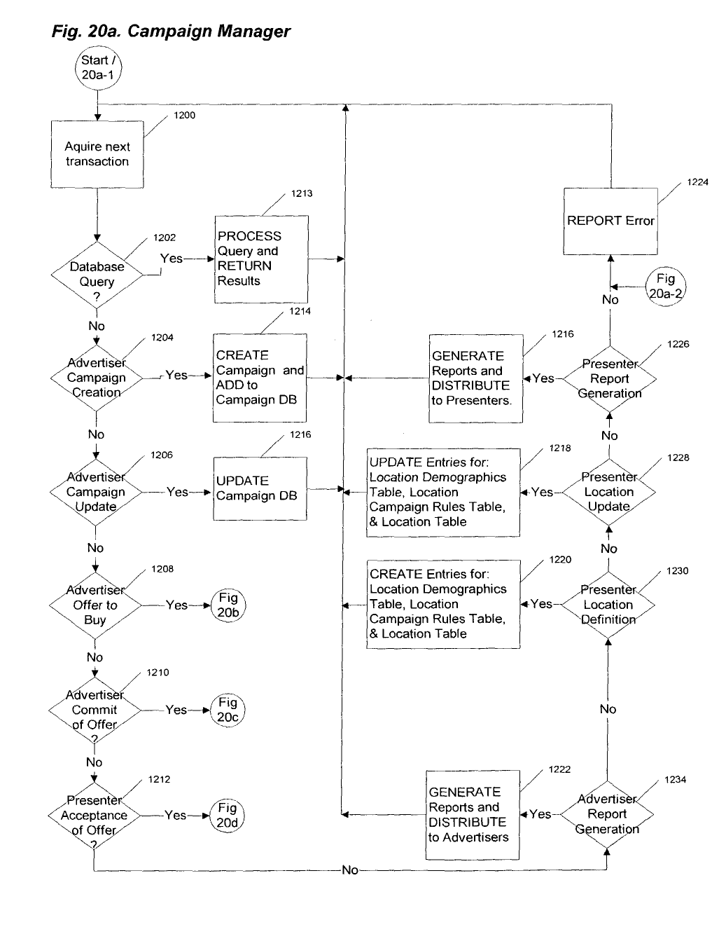

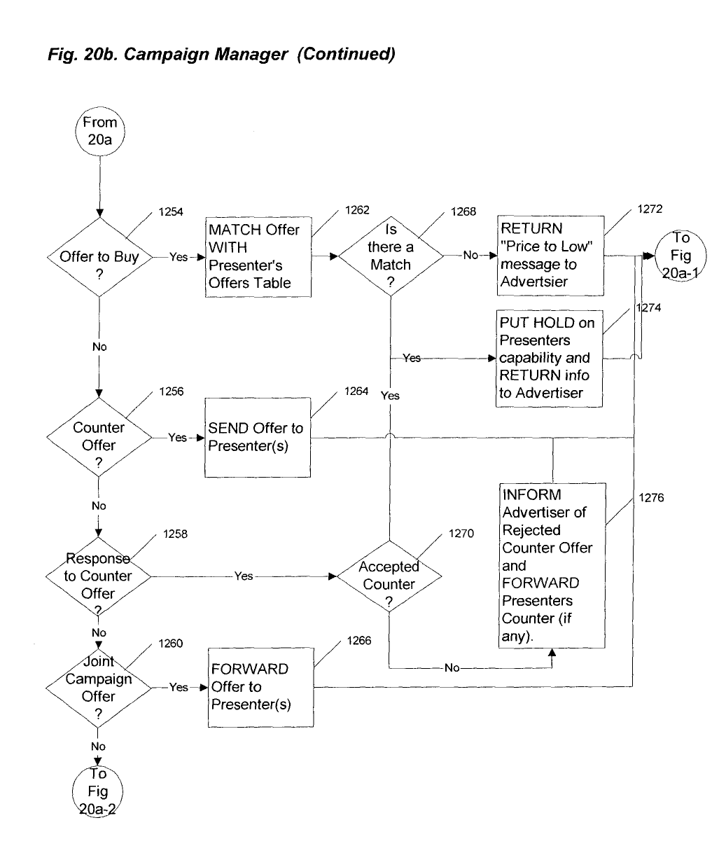

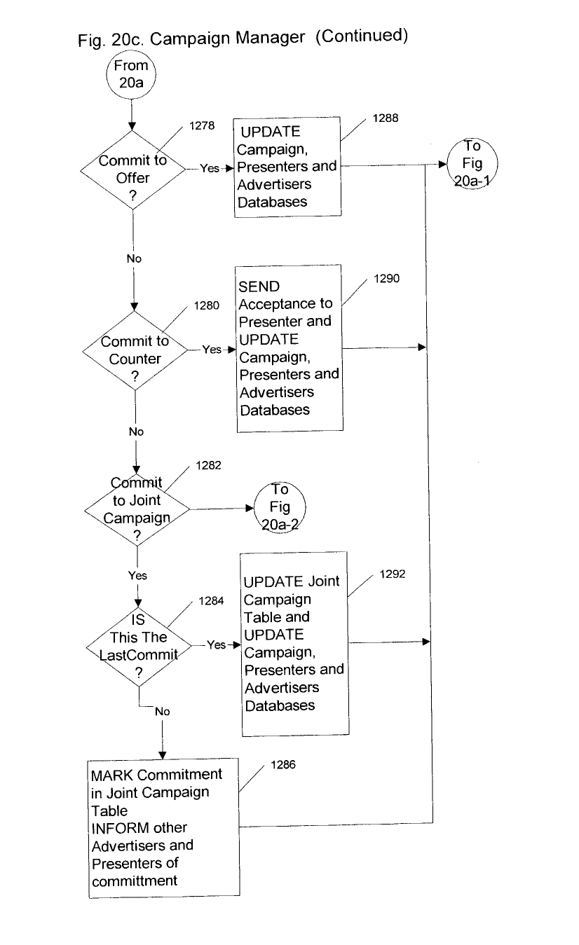

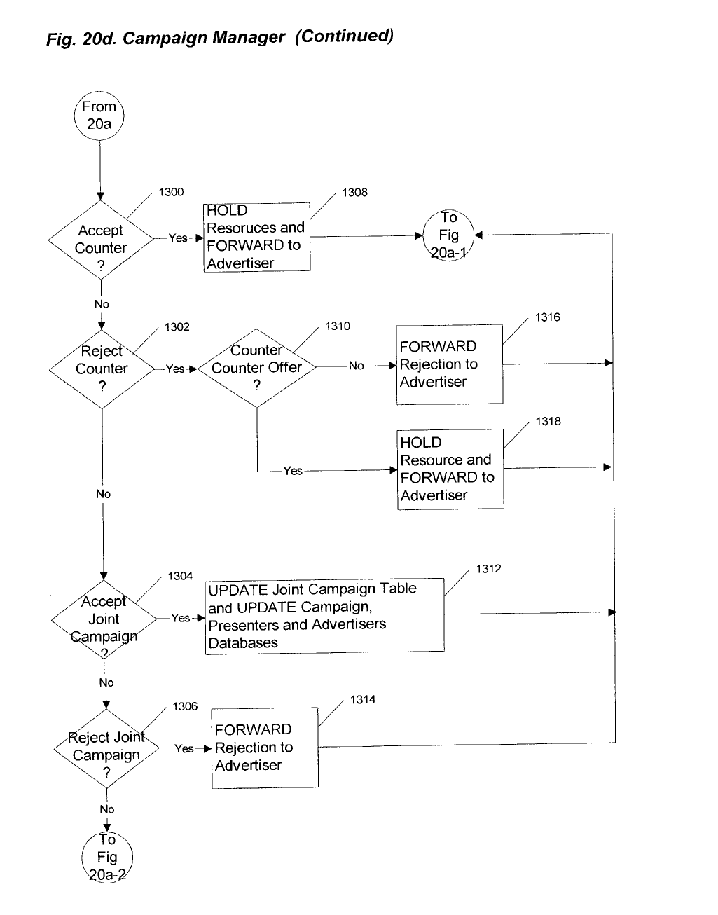

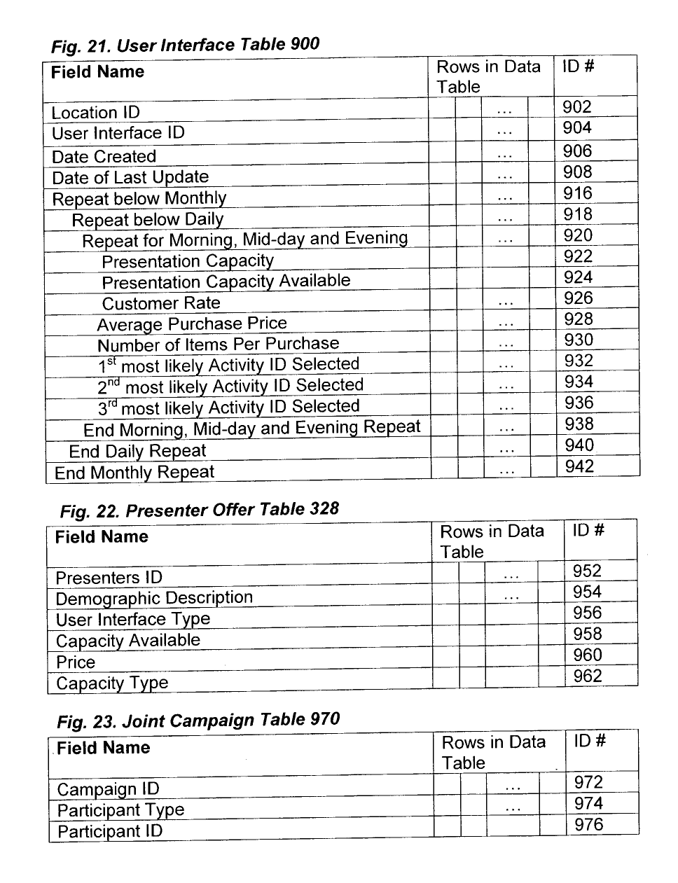

In FIG. 2., Advertiser Workstation 10, is composed of CPU 40, a conventional microprocessor with a Bus 46 that connects it to Disk Drive(s) 42, a WAN Adapter 44, a Program Memory 48 and a Data Memory 50. Data Memory contains an Advertiser Offer Table 100, Campaign Table 102, and a Location Table 104. These are also stored on Disk Drive 42. Program Memory 48 contains Operating System 60, Data Base Software 62, Text Editor 64, Graphics Editor 66, Video Editor 68 and Sound Editor 70, which are typically commercially available software producing their outputs in standard formats. Program Memory 72 also contains FIGS. 20a, b, c, and d. Campaign Manager Interface 72 software, which under control of advertiser, uses contents of Data Memory 50, various editors, and information received from Central Server 22, to construct campaigns using Campaign Manager 166 on Central Server 22. FIG. 3. illustrates further details of Central Server 22. Central Server 22 performs the functions of collecting customer data and location data, analyzing data to extract information concerning buying habits and thinking characteristics of customers, and information about the performance characteristics of location. CPU 140 is a conventional microprocessor with a Bus 146 that connects it to Disk Drive(s) 142, a WAN Adapter 144, a Program Memory 148, and a Data Memory 150. Program Memory 148 contains Operating System 160, Database Software 162, Transaction Manager 164, Campaign Manager 166 application, and Report Generation Software 168, and OLAP (On Line Application Processing) Software 170. OLAP software 170 queries, maintains, generates reports, and performs accounting from: Presenters Database 180, composed of Location Table 104 (FIG. 8), Presenters Table 330 (FIG. 10), Location Profile Table 232 (FIG. 12), Customer/Location Profile Table 650 (FIG. 13), Location Demographics Table 322 (FIG. 14), Location Campaign Rules Table 326 (FIG. 15), Point of Sale Terminal Table 900 (FIG. 21), and Presenter Offer Table 328 (FIG. 22); Advertisers Database composed of: Advertisers Table 106 (FIG. 9), and Advertiser Offer Table 100 (FIG. 18); and Campaign Database 184 composed of Campaign Table 102 (FIG. 7), Activity Dialog Table 850 (FIG. 16), Location Activity List 324 (FIG. 17) and, optionally, Joint Campaign Table 970 (FIG. 23); which are databases defining presenters capabilities, advertisers needs and various offers that are known.

This information is stored using Database Software 162 into Data Memory 150 and subsequently onto Disk Drive(s) 142. Campaign Manager 166, described in FIGS. 20a, 20b, 20c, and 20d, uses the information in: Presenters Database 180, Advertisers Database 182, and Campaign Database 184 to supply users of Advertiser Workstation 10 and Presenter Workstation 24 with the information they need, and to store information that they generate. This information is stored and retrieved using Database Software 162 into Data Memory 150 and subsequently onto Disk Drive(s) 142.

FIG. 4. is a representation of a Location Server 16. CPU 200 is a conventional microprocessor with a Bus 208 that connects it to Disk Drive(s) 202, a LAN Adapter 204, a WAN Adapter 206, a Program Memory 210, and a Data Memory 212. Location Server 16 communicates with Central Server 22, via WAN Adapter 206 to acquire information in Data Memory 212, which is also stored on Disk Drive(s) 202. The tables are: Instrumentation Table 106 (FIG. 11), Location Profile table 232 (FIG. 12), Customer/Location Profile Table 234 (FIG. 13), and Campaign Table 236 (FIG. 7).

Location Server 16 also communicates via Local Area Network Adapter 204 and LAN 18 to other components of the system, specifically User Interface 20. Program Memory 210 contains a commercial Operating System 220 and Database Software 222, Activity Manager 224 (FIG. 20), and Measurement Manger 226, which are shown in FIG. 21. Measurement Manager. These applications receive, present, measure, and report on, campaigns targeted to the location serviced by Location Server 16.

FIG. 5. is a representation of User Interface 20. User Interface Micro-computer 256 is a conventional microprocessor with attachments that connects it to Input Device 250, a LAN 270, a Speaker 251, Microphone 253, Touch Screen 260, Magnetic Stripe Reader 268 and Processor Memory 252. Speaker 251, and Touch Screen 260 are used to present campaign assets (screen images and sounds) to customers. Input Device 250, Microphone 253, and Magnetic Stripe Reader 268 are used to collect customer responses to the information presented. This information is stored in Processor Memory 252 as Application Data 264 and forwarded via LAN 270 to Location Server 16. LAN 270 receives screen images and audio data from Location Server 16. These are stored in Processor Memory 252 by User Interface Micro-computer 256 and sent to Touch Screen 260 or Speaker 251 under control of Application 262.

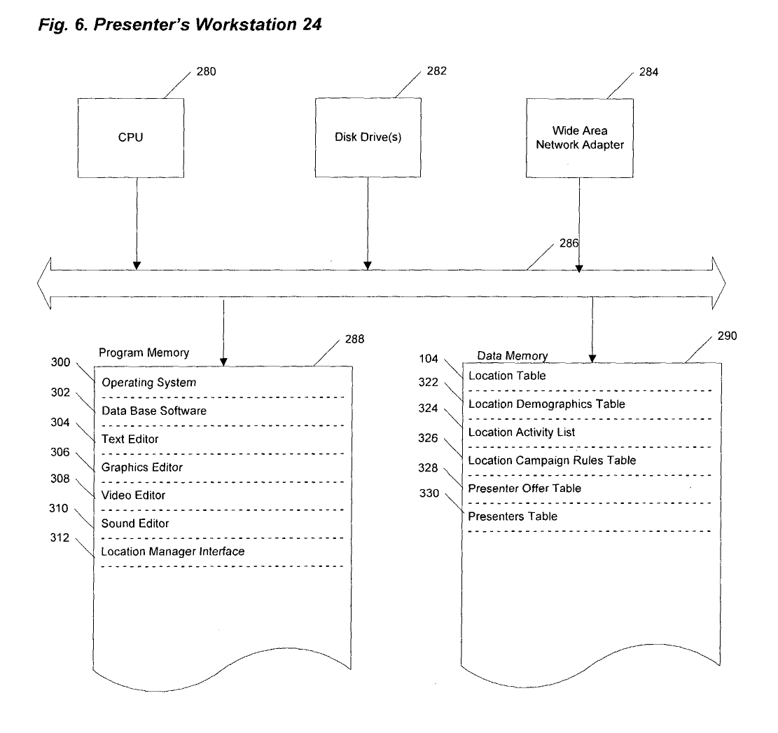

FIG. 6. Is a representation of Presenter Workstation 24, and is composed of CPU 280 is a conventional microprocessor with a Bus 286 that connects it to Disk Drive(s) 282, a WAN Adapter 284, a Program Memory 288 and a Data Memory 290. Data Memory 290 contains Location Table 104, Location Demographics Table 322, Location Activity List 324, Location Campaign Rules Table 326, Presenter Offer Table 328, and Presenters Table 330. These are also stored on Disk Drive 282. Program Memory 288 contains Operating System 300, Data Base Software 302, Text Editor 304, Graphics Editor 306, Video Editor 308 and Sound Editor 310, which are typically commercially available software producing their outputs in standard formats.

Program Memory 288 also contains Location Manager Interface 312, software which, under control of Location Manager 172 and presenter, uses contents of Data Memory 290, various editors, and information received from Location Manager 172, located in Central Server 22, to define the locations that will participate in campaigns, the capabilities of those locations, the limits on what kind of campaigns that will be hosted at each location, and the demographics of the locations. This information is stored in Data Memory 290 in the form of Location Table 104, Location Demographics Table 322, Location Activities List 324, Location Campaign Rules Table 326, Presenter Offer Table 328, Presenter Table 330, and forwarded to Location Manger 172 via Central Server 22 and WAN Adapter 284. Presenter Workstation 24 can update this information by querying Central Server 22 via WAN Adapter 284, downloading and updating location information and re-transmitting it to Central Server 22.

FIG. 7. is a representation of Campaign Table 102, composed of a Campaign ID 362 that uniquely identifies each campaign, Advertisers ID 363 that identifies the entity doing the campaign, Activity ID 364 that uniquely identifies an activity, Location ID 366 that identifies a location where activity is to be presented, Number Of Times Activity Is To Be Presented 368 is a count of the number of times an activity is to be offered at the location, Activity Value 370 is the fee for presenter, if the activity is completed successfully, Activity Type 372 identifies the kind of activity (ad, coupon, discount, offer to sell . . . ), Start Date 374 and End Date 376 define start and ending days of campaign, and Time Of Day To Be Presented 378 specifies when the activity should be presented.

There is one entry in Campaign Table 102 for each Campaign ID 362, Activity ID 364, and Location ID 366 triplet. When Central Server 22 prepares to send a campaign to a Location Server 16, it inquires of Campaign Table 102 for Location ID 366 for the location, and sends those rows to the specified location.

FIG. 8. is a representation of Location Table 104, composed of Location ID 392 which is unique for each location, Geographic Code 394 that identifies geographic location of location, and Presenter ID 396 which identifies presenter associated with this location. Geographic Code 394 may be a Zip Code, or latitiude and longitude. Location Table 104 is used during construction of campaign to match advertisers needs for specific geographic coverage with potential presenters.

FIG. 9. is a representation of Advertisers Table 106, composed of an Advertiser ID 502 that uniquely identifies and advertiser, Name 504 that contains the name of the entity doing the advertising, Address 506 that contains the mailing address of the entity, Phone Information 508 which contains the phone numbers of the entity, and Billing Information 510 for the advertiser.

FIG. 10. is a representation of Presenters Table 330, composed of a Presenters ID 532 that uniquely identifies and presenter, Name 534 that contains the name of the entity doing the presenting, Address 536 that contains the mailing address of entity, Phone Information 538 which contains the phone numbers of the entity, and Payables Information 540 for the presenter.

FIG. 11. is a representation of Instrumentation Table 106, composed of a Record Type Flag 562 which indicates what type of event (Screen or Customer Selection) is being recorded, a Customer ID 564 that identifies the customer being serviced (an ID number or “anonymous”), a Location ID 566 that uniquely identifies the location where the activity is taking place, a User Interface ID 568 that identifies the User Interface in the location the customer is using, a Session Number 570 which is assigned dynamically in location and is unique to the session within a given time period (say one month), a Screen ID 572 that is associated with instrumented activity, and a Month 576, Day-of-week 578, Time 580, and Time-of-day (Morning, Mid-day, Evening . . . ) 582 fields that identify when the instrumented activity took place. This information is used to bill advertisers and distribute payments to presenters.

FIG. 12. is a representation of Location Profile Table 232, composed of a Location ID 592 which uniquely identifies the location, a User Interface ID 594 which identifies the User Interface that this profile represents, a Date Created 596 which indicates when this User Interface was configured into the location, a Date of Last Update 598 which specifies the profile's currency, a structure that is repeated monthly, daily, and by time-of-day, containing: a Customer Rate 612 which is number of customers processed per hour during that period, an Average Purchase Price 614 for an order processed in that period, a Number of Items Per Purchase 616 for an order processed in that period, a 1^{st} (618), 2^{nd} (620) and 3^{rd} (622) most likely Activity ID Selected by customer processed in that period; and a Home Screen ID 630 that specifies first screen to be presented at User Interface.

FIG. 13. is a representation of Customer/Location Profile Table 234, composed of a Location ID 652 which uniquely identifies the location, a Customer ID 654 which identifies the customer that this profile represents, a Date Created 656 which indicates when this customer was first observed in the location, a Date of Last Update 658 which specifies the profile's currency, a structure that is repeated monthly, daily, and by time-of-day, containing: Customer Repeats 672 which is a count of the number of times customers was processed during that period, an Average Purchase Price 674 for orders processed in that period, a Number of Items Per Purchase 676 for an order processed in that period, a 1^{st (678),} 2^{nd} (680) and 3^{rd} (682) most likely Activity ID Selected by customer processed in that period; and a Home Screen ID 690 that specifies first screen to be presented at User Interface.

FIG. 14. is a representation of Location Demographics Table 322, composed of a Location ID 782 that uniquely identifies the location, a Location Type 784 that defines the type of location (grocery, variety, hardware, fast food, ATM, kiosk . . . ), a Location Name 786, and Location Demographics (List) 788 which describes characteristics that are important to that Location Type.

This data is used by an advertiser to determine if a location has suitable demographics for the campaign.

FIG. 15. is a representation of Location Campaign Rules Table 236, composed of a Location ID 802 that uniquely identifies a location, an Advertiser Exclusion List 804 that identifies entities that a presenter does not wish to have advertise in a presenters locations, an Activity Complexity Level 806 which indicates how many screens a presenter will allow in a dialog, and a Screen Complexity Level 808 that indicates how complex of a screen is permitted by the presenter.

FIG. 16. is a representation of Activity Dialog Table 238, composed of an Activity ID 852 that uniquely identifies an activity, a Screen ID 854 that identifies a screen to be displayed for this activity, a Screen Order 856 that specifies the order of presentation of screens for activities with more than one screen, a Positive Response Screen ID 858 that specifies what screen is to be presented if there is a positive response to this screen, a Positive Response Trigger Code 860 that instructs the system what to do if there is a positive response to this screen (these codes specify actions like: issue a product coupon, sell offered product . . . ), a Negative Response Screen ID 862 that specifies what screen is to be presented if there is a negative response to this screen, and a Negative Response Trigger Code 864 that instructs the system what to do if there is a positive response to this screen (these codes specify actions like: count rejection, ignore . . . ).

FIG. 17. is a representation of Location Activity List 324, composed of an Activity ID 882 (see FIG. 16. Activity ID 852), a Remaining Number To Be Presented 884 which indicates the balance of the number of times this activity can be presented in this location.

FIG. 18. is a representation of Advertiser Offer Table 100, composed of a Advertisers ID 892, a Demographic Requirements 894, a User Interface ID 896, a Capacity Needed 898 which specifies the capacity required at Price 900, and a Capacity Type 902 that describes the kind of offering the capacity required (advertisement, coupon offer, product sale offer . . . ).

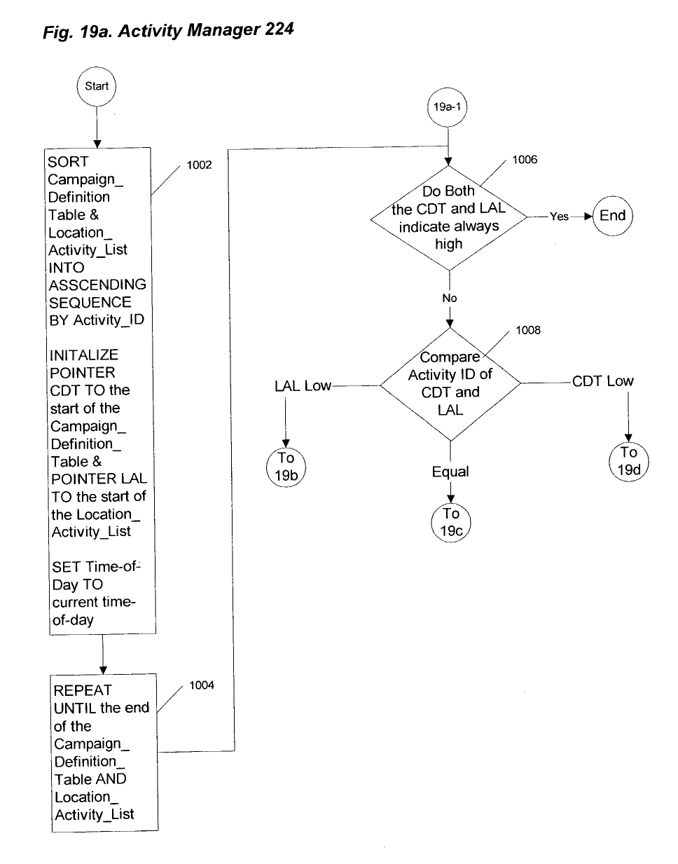

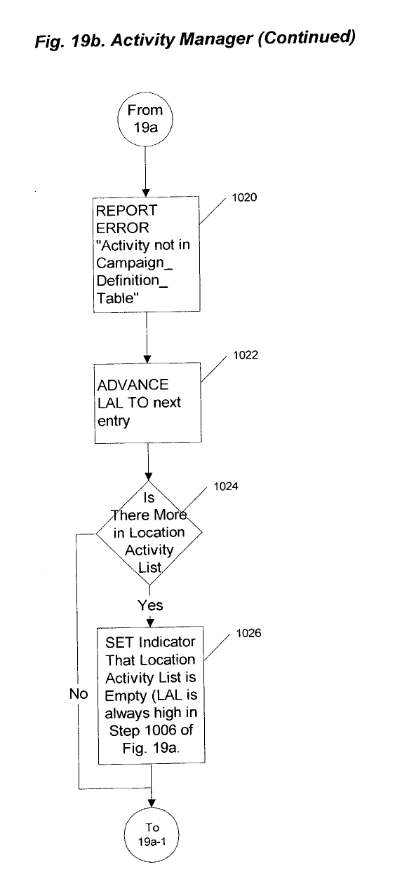

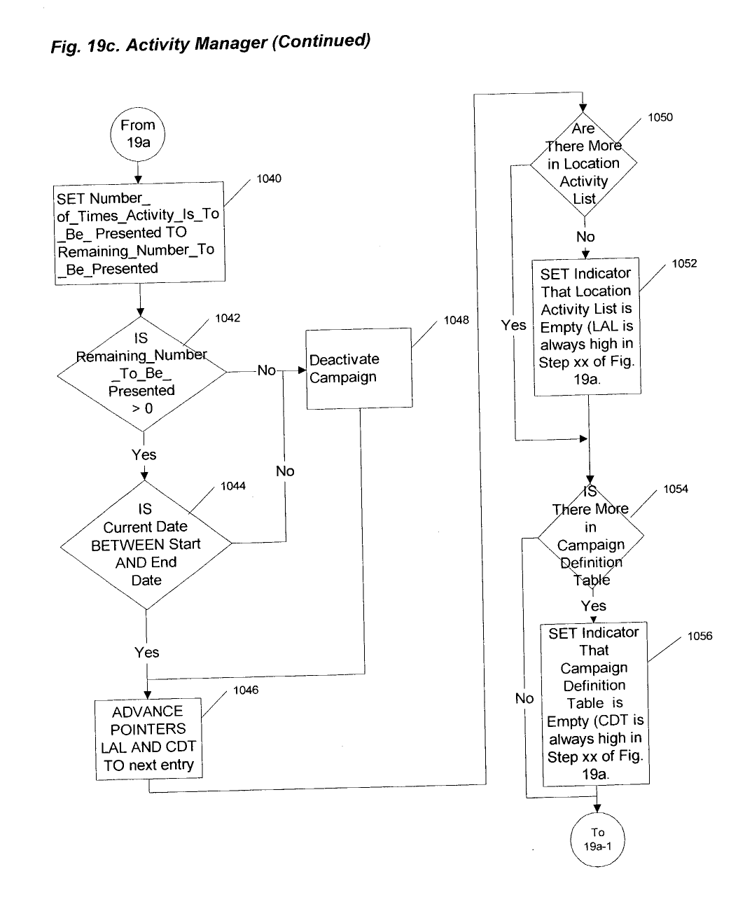

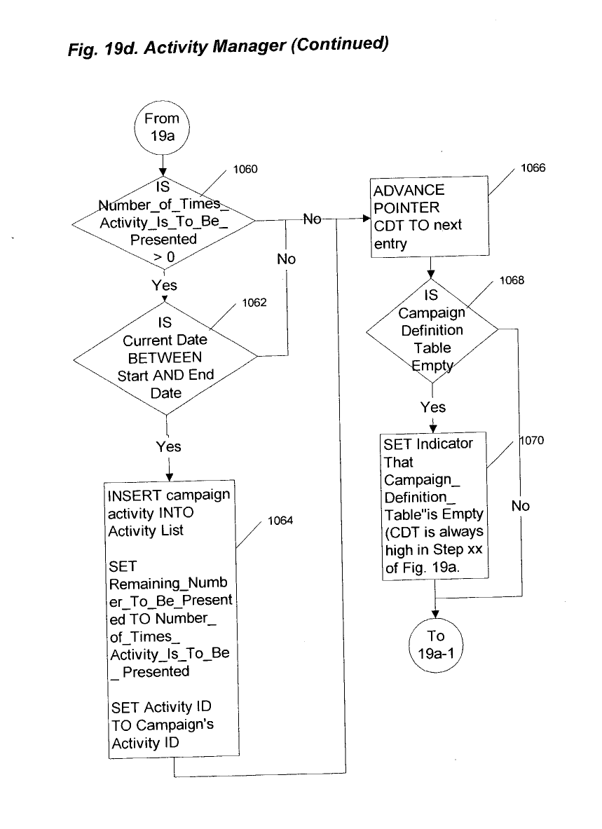

FIG. 19a. Is a first of four flow diagrams that describe Activity Manager 324, which runs in Location Server 16. Step 1002 prepares Campaign Table 102 and Location Activity List 324 by sorting them into ascending sequence, setting up pointers CDT and LAL to start of Campaign Table 102 and Location Activity List 324, respectively. It then sets Time-of-Day to current time-of-day, as supplied by Operating System 220. Step 1004 initializes a loop that traverses both Campaign Table 102 and Location Activity List 324. Step 1006 looks at entries refrenced by CDT and LAL to determine if both have been completely processed. If yes, processing is terminated. Otherwise, control passes to Step 1008. Step 1008 check to see the relationship between Campaign Table's 102 Activity ID 364 and Location Activity List's 324 Activity ID 882. If Location Activity List's 324 Activity ID 882 is low, control passes to FIG. 19b, Step 1020. If they are equal, control passes to FIG. 19c, Step 1040. Otherwise control passes to FIG. 19d, Step 1060.

FIG. 19b. Step 1020 report an error as Location Activity List 324 contains an entry that is not in Campaign Table 102. (As Location Activity List 324 is built from Campaign Table 102, this should not be possible.) Step 1024 checks to see if Location Activity List 324 has more entries to be processed. If yes, control passes to Step 1026. Otherwise control passes to FIG. 19a at entry point 19a-1. Step 1026 sets an indicator used by Step 1006 and control passes to FIG. 19a at entry point 19a-1.

FIG. 19c. Step 1040 copies Location Activity List 324 Remaining Number To Be Presented 884 to Campaign Table 102 Number Of Times Activity Is To Be Presented 368. Step 1042 checks Remaining Number To Be Presented 884 to see if it is greater than zero. If so, the campaign is still active and control passes to Step 1044. Otherwise control passes to Step 1048. Step 1044 checks to see if Current Date is in the interval defined by Campaign Table 102 Start Date 374 and End Date 376. If it is, control is passed to Step 1046, otherwise control passes to Step 1048. Step 1046 advances pointers LAL and CDT and passes control to step 1050.

Step 1048 deactivates the campaign by removing the entry from Location Activity List 324 and passes control to Step 1046. Step 1050 checks to see if Location Activity List 324 has more entries to be processed. If yes, control passes to Step 1054. Otherwise control passes to Step 1052. Step 1052 sets the indicator used by Step 1006 and control passes to Step 1054. Step 1054 checks to see if Campaign Table 102 has more entries to be processed. If yes, control passes to Step 1056. Otherwise control passes to FIG. 19a at entry point 19a-1. Step 1056 sets indicator used by Step 1006 and control passes to FIG. 19a at entry point 19a-1.

FIG. 19d. Step 1060 checks to if the entry in Campaign Table 102 Number Of Times Activity Is To Be Presented 368 is greater than zero. (This means campaign can be activated if test is Step 1062 is passed.) If so control passes to Step 1062, otherwise to Step 1066. Step 1062 checks to see if Current Date is in interval defined by Campaign Table 102 Start Date 374 and End Date 376. If it is control is passed to Step 1064, otherwise control passes to Step 1066. Step 1064 activates the campaign by inserting a new element into Location Activity List 324 and moves Campaign Table 102 Number Of Times Activity Is To Be Presented 368 to Location Activity List 324 Remaining Number To Be Presented 884. It then moves Campaign Table's 102 Activity ID 364 to Location Activity List's 324 Activity ID 882. Step 1066 advances CDT pointer to next entry. Step 1068 checks to see if Campaign Table's 102 is empty (all items have been processed). If so, control passes to Step 1070, otherwise control passes to FIG. 19a at entry point 19a-1. Step 1070 sets the indicator used by Step 1006 and control passes to FIG. 19a at the entry point 19a-1.

FIG. 20a. is a first of four flow diagrams that describe the operation of Campaign Manager. Step 1200 aquires the next transaction from Transaction Manager's 164 transaction queue and passes control to Step 1202. Step 1202 determines if transaction is of the Query type, if so control passes to Step 1213 which processes the query and returns the results to the advertiser or presenter. Otherwise it passes to Step 1204. Step 1204 determines if the transaction is of the Advertiser Campaign Creation type, if so control passes to Step 1214. Otherwise it passes to Step 1206. Step 1214 creates an entry in Campaign Table 102 by generating a Campaign ID 362, assigning an Activity ID 364, and filling in Advertisers ID 363, Location ID 366, Number Of Times Activity Is To Be Presented 368, Activity Value 370, Activity Type 372, Start Date 374, End Date 376, and Time Of Day To Be Presented 378 from the transaction data.

Step 1206 determines if transaction is of Advertiser Campaign Update type, if so control passes to Step 1216. Otherwise it passes to Step 1208. Step 1216 creates an entry in Campaign Table 102 by using existing Campaign ID 362, assigning an Activity ID 364, and using Advertisers ID 363, Location ID 366, Number Of Times Activity Is To Be Presented 368, Activity Value 370, Activity Type 372, Start Date 374, End Date 376, Time Of Day To Be Presented 378 from transaction data. Each activity after the first requires a transaction of this type to add it to campaign.

Step 1208 determines if the transaction is of “Advertiser Offer to Buy” type, if so control passes to FIG. 20b. Otherwise it passes to Step 1210. Step 1210 determines if transaction is of Advertiser Commit To Offer type, if so control passes to FIG. 20c. Otherwise it passes to Step 1212. Step 1212 determines if transaction is of Presenter Acceptance Of Offer type, if so control passes to FIG. 20d. Otherwise it passes to Step 1234.

Step 1234 determines if transaction is of Advertiser Report Generation type, if so control passes to Step 1222. Otherwise it passes to Step 1230. Step 1222 generates reports and distributes them to advertisers. It uses standard reporting technology that extracts report information from various databases on Central Server 22 using Report Generation Software 170. Step 1230 determines if transaction is of Presenter Location Definition type, if so control passes to Step 1220. Otherwise it passes to Step 1228. Step 1220 extracts Location ID 782, Location Type 784, Location Name 786, and Location Demographics 788 from transaction and builds an entry for Location Demographics Table 322. It then extracts Location ID 802, Advertiser Exclusion List 804, Activity Complexity Level 806, and Screen Complexity Level 808 from the transaction to build an entry for Location Campaign Rules Table 236. Finally it extracts Location ID 392, and Geographic Code 394 from the transaction, using that, and Presenter ID 396 of the presenter to build a Location Table 104 entry.

Step 1228 determines if the transaction is of Presenter Location Update type, if so control passes to Step 1218. Otherwise it passes to Step 1226. Step 1218 extracts Location ID 782, Location Type 784, Location Name 786, and Location Demographics 788 from the transaction and updates an entry in Location Demographics Table 322, having the same Location ID 782. It then extracts Location ID 802, Advertiser Exclusion List 804, Activity Complexity Level 806, and Screen Complexity Level 808 from the transaction to update an entry in Location Campaign Rules Table 326, having the same Location ID 802. Finally it extracts Location ID 392, and Geographic Code 394 from the transaction, using that, and Presenter ID 396 of the presenter to build a Location Table 104 entry.

Step 1226 determines if the transaction is of Presenter Report Generation type, if so control passes to Step 1216. Otherwise it passes to Step 1224. Step 1216 generates reports and distributes them to presenters. It uses Report Generation Software 168 that extracts report information from various databases on Central Server 22.

Step 1224 reports to Transaction Manager 164 that there was an invalid transaction and returns to Transaction Manager 164. Step 1224 is encountered when the transaction is not defined in system. It informs the system that transaction is in error and returns control to FIG. 21a. Step 1200.

FIG. 20b. starts with Step 1254, which determines if transaction is an offer to buy User Interface 20 capacity. If so, control passes to Step 1262, which matches the offer with capacity in Presenter Offer Table 328 and passes control to Step 1268, which determines if there is a match. If there is no match, control passes to Step 1272 which returns a message to advertiser indicating the price offered by advertiser was too low and passes control to FIG. 21a. Step 1200. Otherwise control passes to Step 1274, which puts a hold on presenter's capacity, returns information about match to the advertiser, and passes control to FIG. 21a. Step 1200.

If Step-1254 was not an offer to buy, control passes to Step 1256, which determines if the transaction is a counter offer. If so, control passes to Step 1264, otherwise to Step 1258. Step 1264 sends the offer to as many presenters as specified and passes control to FIG. 21a. Step 1200.

Step 1258 determines if the transaction is a Response To Counter Offer. If so control is passed to Step 1270, otherwise to Step 1260. Step 1270 determines if the presenter accepted the counter offer. If so, control passes to Step 1274 (see above), otherwise to Step 1276. Step 1276 informs the advertiser that the counter offer was rejected and includes any counter offer from presenter, and passes control to FIG. 21a. Step 1200.

Step 1260 determines if the transaction is an offer to participate in a joint campaign. If so, control passes to Step 1266, otherwise control passes to FIG. 21a, Step 1224. Step 1266 forwards the offer to the presenters specified in the transaction and then passes control to FIG. 21a. Step 1200.

FIG. 20c. starts with Step 1278, which determines if the transaction is a commitment to buy User Interface 20 capacity. If it is, control passes to Step 1288, which updates Campaign Database 184, Advertiser Database 182, and Presenter Database 180 with control passing to FIG. 21a. Step 1200. Otherwise control passes to Step 1280. Step 1280 determines if transaction is a commitment to accept a counter offer for User Interface 20 capacity. If so control passes to Step 1290 which sends acceptance to the presenter and updates Campaign Database 184, Advertiser Database 182, and Presenter Database 180 with control passing to FIG. 21a. Step 1200. Otherwise control passes to Step 1282.

Step 1282 determines if transaction is a commitment to participate in a joint campaign. If not control passes to FIG. 21a, Step 1224. Otherwise control passes to Step 1284, which determines if the commitment is the last one needed for the campaign. If so control passes to Step 1292 which marks the campaign in Campaign Database 184 as a committed campaign and updates Campaign Database 184, Advertiser Database 182, and Presenter Database 180. Otherwise control passes to Step 1286, which marks commitment in Joint Campaign Table 970 with control passing to FIG. 21a. Step 1200.

FIG. 20d. starts with Step 1300, which determines if the transaction is a presenter's acceptance of a counter offer to buy User Interface 20 capacity. If it is, control passes to Step 1308, which updates Campaign Database 184 to indicate acceptance and informs advertiser of acceptance, then control passes to FIG. 21a. Step 1200. Otherwise control passes to Step 1302. Step 1302 determines if the transaction is a rejection of a counter offer for User Interface 20 capacity. If not, control passes to Step 1304; otherwise control passes to Step 1310, which determines if the rejection is in the form of a counter to a counter-offer. If so control passes to Step 1318, which holds resources and forwards the counter counter-offer to the advertiser with control passing to FIG. 21a. Step 1200. Otherwise control passes to Step 1316, which forwards the rejection to the advertiser and passes control to FIG. 21a, Step 1200.

Step 1304 determines if the transaction is an acceptance of a joint campaign. If not control passes to Step 1306, otherwise control passes to Step 1312 which updates Joint Campaign Table 970, Campaign Database 184, Advertiser Database 182, and Presenter Database 180, and then passes control to FIG. 21a. Step 1200.

Step 1306 determines if the transaction is a rejection of a joint campaign. If not control passes to FIG. 21a-2, Step 1224. Otherwise control passes to Step 1314 which forwards the rejection to the other advertisers and presenters involved with the joint campaign, and passes control to FIG. 21a, Step 1200, and sends acceptance to presenter and updates Campaign Database 184, Advertiser Database 182, and Presenter Database 180 with control passing to FIG. 21a., Step 1200.

FIG. 21. is a representation of User Interface Table 900, composed of: Location ID 902 that uniquely identifies the location housing User Interface 20; User Interface ID 904 which uniquely identifies User Interface 20 associated with this table entry; Date Created 906 which indicates when this User Interface 20 was first activated in the location; Date of Last Update 908 which specifies the table's currency; and a structure that is repeated monthly, daily, and by day-part, containing: Presentation Capacity 922 which specifies the amount of User Interface 20 time that can be used for presenting campaigns, Presentation Capacity Available 924 which specifies the amount of User Interface 20 time that for presenting campaigns that has not yet been sold, Customer Rate 926 which specifies the number of customers per hour using User Interface 20, Average Purchase Price 928 which specifies the amount spent per customer per purchase for this User Interface 20, Number of Items Per Purchase 930 which specifies the number of items per purchase for this User Interface 20, 1^{st} most likely Activity ID Selected 932, 2^{nd} most likely Activity ID Selected 934, 3^{rd} most likely Activity ID Selected 936 which specify the three most likely activities to be used in the specified time interval at this User Interface 20. The remaining three fields complete the repeated data structure.

FIG. 22. is a representation of Presenter Offer Table 328, composed of a Presenters ID 952 (see Presenters ID 532 in FIG. 10. Presenters Table 330, a Demographic Description 954 which specifies the demographics the presenter is offering(Note: each unique demographic description requires a separate entry in the table), a User Interface ID 956 which describes the capability of the User Interfaces 20 that this offer is for (Note: each type requires a separate entry in the table), a Capacity Available 958 which specifies amount of capacity required at Price 960, and a Capacity Type 962 that describes kind of offering capacity is required for (advertisement, coupon offer, product sale offer . . . ).

FIG. 23. is a representation of Joint Campaign Table 970, composed of a Campaign ID 972, Participant Type 974, and Participant ID 976, used to tie various advertisers and presenters together in a common structure that represents a joint campaign. Campaign ID 972 is same as Campaign ID 362. When a Campaign ID 362 appears in Joint Campaign Table 970 it indicates that campaign is a joint campaign. Participant Type 974 indicates whether entry in Joint Campaign table 970 is an advertiser or a presenter, and Participant ID 976 will be either an Advertiser ID 502 or Presenter ID 532 depending on setting of this field.

It should be understood that foregoing description is only illustrative of invention. Various alternatives and modifications can be devised by those skilled in art without departing from invention. Accordingly, present invention is intended to embrace all such alternatives, modifications, and variances, which fall within scope of appended claims.

What is claimed is:

1. A system for enabling delivery of advertisements, offers or promotions from a provider to a determined demographic segment of users via a plurality of user terminals accessible over a communication network, said system comprising:
server computer means coupled to said communication network and including memory for storing capability data regarding said user terminals, said capability data comprising information from which demographic characteristics can be determined of individuals who have access to said user terminals;
communications means associated with said server computer means for receiving information from said provider regarding advertisements, offers or promotions to be provided to a determined demographic segment; and
program means for controlling said server computer means to analyze said information from said provider in relation to said capability data and to provide output indicative of a population of said user terminals that will come closest to providing access to said determined demographic segment.

2. The system as recited in claim 1, wherein said capability data further comprises terminal locations.

3. The system as recited in claim 1, wherein said capability data further comprises rules regarding data to be presented or not presented over determined ones of said user terminals.

4. The system as recited in claim 1, wherein said program means is further configured to control said server computer means to deliver said advertisements, offers or promotions from a provider via said network to said population of said user terminals that comes closest to providing access to said determined demographic segment.

5. The system as recited in claim 4, wherein said program means is further configured to control said server computer means to receive responses from said population of users, via said network, in response to presentation of said advertisements, offers or promotions and to provide information regarding said responses to said provider.

6. The system as recited in claim 1, wherein said user terminals comprise point of sale terminals positioned in retail facilities.

7. The system as recited in claim 6, wherein said user terminals are configured to accept at least one of magnetic card, tactile, or audio responses from a user.

8. The system as recited in claim 6, wherein said user terminals are configured to output response tokens in a printed form or a premium in response to a user's interaction with a user terminal and instructions from said server computer means.

9. A memory media including instructions for controlling a server computer to deliver advertisements, offers or promotions from a provider to a determined demographic segment of users via a plurality of user terminals accessible over a communication network, said server computer means coupled to said communication network and including memory for storing capability data regarding said user terminals, said capability data comprising information from which demographic characteristics can be determined of individuals who have access to said user terminals, said memory media comprising:
a) means for controlling said server computer to receive information from said provider regarding advertisements, offers or promotions to be provided to a determined demographic segment; and
b) means for controlling said server computer to analyze said information from said provider in relation to said capability data and to provide output indicative of a population of said user terminals that will come closest to providing access to said determined demographic segment.

10. The memory media as recited in claim 9, wherein said capability data further comprises terminal locations.

11. The memory media as recited in claim 9, wherein said capability data further comprises rules regarding data to be presented or not presented over determined ones of said user terminals.

12. The memory media as recited in claim 9, further comprising:
c) means for controlling said server computer to deliver said advertisements, offers or promotions from a provider via said network to said population of said user terminals that comes closest to providing access to said determined demographic segment.

13. The memory media as recited in claim 12, further comprising:
d) means for controlling said server computer to receive responses from said population of users, via said network, in response to presentation of said advertisements, offers or promotions and to provide information regarding said responses to said provider.

14. The memory media as recited in claim 9, wherein said user terminals comprise point of sale terminals positioned in retail facilities.

15. The memory media as recited in claim 14, wherein said user terminals are configured to accept at least one of magnetic card, tactile, or audio responses from a user.

16. The memory media as recited in claim 14, wherein said user terminals are configured to output response tokens in a printed form or a premium in response to a user's interaction with a user terminal and instructions from said server computer means.
